(19) United States
(12) Patent Application Publication
(10) Pub. No.: US 2019/0115848 A1
(43) Pub. Date: Apr. 18, 2019

(54) POWER CONVERTER

(71) Applicant: CALSONIC KANSEI CORPORATION, Saitama-shi, Saitama (JP)

(72) Inventors: Fumihiro OKAZAKI, Saitama-shi, Saitama (JP); Gen OKUZUKA, Saitama-shi, Saitama (JP); Yuuichirou NOMURA, Saitama-shi, Saitama (JP); Masaharu NAGANO, Saitama-shi, Saitama (JP)

(73) Assignee: CALSONIC KANSEI CORPORATION, Saitama-shi, Saitama (JP)

(21) Appl. No.: 16/097,137

(22) PCT Filed: Apr. 25, 2017
(86) PCT No.: PCT/JP2017/016418

§ 371 Date: Oct. 26, 2018

(30) Foreign Application Priority Data
Apr. 27, 2016 (JP) 2016-089221

(51) Int. Cl. H02M 7/48; H02J 7/02

(52) U.S. Cl. CPC H02M 7/48; B60L 2210/40; B60L 2210/10; H02J 7/022

(57) ABSTRACT

A power converter includes: a power module configured to convert direct-current electric power from a power storage apparatus and alternating-current electric power supplied to a load; a DC/DC converter; a charger; a capacitor module having a capacitor for smoothing voltage; and a case configured to accommodate the power module, the DC/DC converter, the charger, and the capacitor module, the case having a cooling surface; wherein, in the case, the power module, the charger, and the DC/DC converter are arranged around the capacitor module, and the DC/DC converter is arranged between the power module and the charger, and wherein the capacitor module is mounted on the cooling surface.

### TECHNICAL FIELD

The present invention relates to a power converter mounted on electric automobiles, hybrid automobiles, and so forth.

### BACKGROUND ART

A power converter mounted on the electric automobiles, hybrid automobiles, and so forth includes a power module and various electronic devices, and there has been a problem in that the size of a housing is increased due to arrangement of respective components.

In order to solve such a problem, JP2013-209078A discloses an electrical unit in which, within an accommodating case, high-voltage components are arranged towards the forward direction of a vehicle and low-voltage components are arranged towards the rearward direction of the vehicle (see Patent Literature 1).

### SUMMARY OF INVENTION

With the conventional technique described in JP2013-209078A, even when an impact input is applied, the low-voltage components function as cushioning materials for the high-voltage components, and so, it is possible to prevent, even when an impact input is applied, the high-voltage components from being exposed without making the size of the unit larger.

On the other hand, in the conventional technique described in JP2013-209078A, there is no consideration of a loss of electrical power in wirings. Especially, there is a problem in that as the paths of the wirings for connecting a power device, a capacitor, and so forth become longer, the resistance value and inductance in the paths are increased, and in turn, the electrical power loss is increased. In addition, there is a risk in that as the paths of the wirings become longer, the wirings tend to pick up noise from other signal lines etc., causing an increase in electric noise.

The present invention has been conceived in light of the above-described problem, and an object thereof is to provide a power converter that is capable of reducing electrical power loss and electric noise and reducing the size of the converter.

According to one aspect of the present invention, a power converter includes a power module configured to convert direct-current electric power from a power storage apparatus and alternating-current electric power supplied to a load; a DC/DC converter, a charger, a capacitor module having a capacitor for smoothing voltage, and a case configured to accommodate the power module, the DC/DC converter, the charger, and the capacitor module, the case having a cooling surface, wherein, in the case, the power module, the charger, and the DC/DC converter are arranged around the capacitor module, and the DC/DC converter is arranged between the power module and the charger, and wherein the capacitor module is mounted on the cooling surface.

According to the present invention, because the power module, the charger, and the DC/DC converter are arranged around the capacitor module in the case, and because the capacitor module is arranged so as to be layered with the DC/DC converter and is arranged on the cooling surface side, it is possible to make distances of electrical power wires between the capacitor module and each of the power module, the charger, and the DC/DC converter shorter. With such a configuration, because resistance and inductance in the paths of direct-current electric power can be made small and the noise can be made less prone to be picked up, it is possible to reduce electrical power loss and electric noise.

### BRIEF DESCRIPTION OF DRAWINGS

FIG. 1 is a functional block diagram of a power converter of a first embodiment according to the present invention.

FIG. 2 is a top view of the power converter of the first embodiment according to the present invention.

FIG. 3A is a side view of the power converter of the first embodiment according to the present invention.

FIG. 3B is a perspective view of the power converter of the first embodiment according to the present invention.

FIG. 4 is a side view of the power converter of a second embodiment according to the present invention.

FIG. 5 is an explanatory diagram of a capacitor module of the second embodiment according to the present invention.

FIG. 6 is an explanatory diagram showing another example configuration of the capacitor module of the second embodiment according to the present invention.

FIG. 7 is a sectional view of the power converter provided with the capacitor module of the second embodiment according to the present invention having another example configuration.

FIG. 8 is an explanatory diagram showing an example configuration of the capacitor module of the second embodiment according to the present invention.

### DESCRIPTION OF EMBODIMENTS

An embodiment according to the present invention will be described below with reference to the drawings.

### First Embodiment

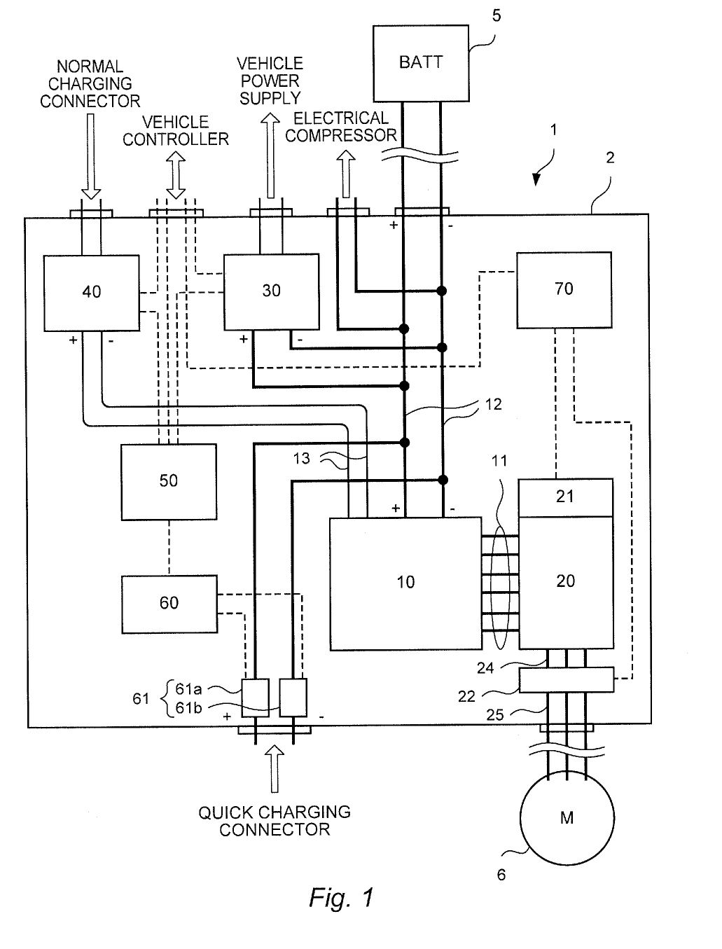

FIG. 1 is a functional block diagram of a power converter 1 of a first embodiment according to the present invention.

The power converter 1 is provided in an electric vehicle or a plug-in hybrid vehicle, and converts electrical power from a power storage apparatus (battery) 5 to electrical power suitable for driving a dynamo-electric machine (motor generator) 6. The motor generator 6 serving as a load is driven by the electrical power supplied from the power converter 1, and thereby, the vehicle is driven.

The power converter 1 converts regenerative electrical power from the motor generator 6 to direct-current electric power and charges the battery 5 therewith. In addition, the power converter 1 charges the battery 5 by supplying electrical power through a quick charging connector or a normal charging connector provided on the vehicle.

The battery 5 is formed of, for example, a lithium ion secondary battery. The battery 5 supplies direct-current electric power to the power converter 1, and battery 5 is charged by direct-current electric power supplied by the power converter 1. The voltage of the battery 5 varies over a range of, for example, from 240 to 400 V, and the battery 5 is charged by inputting higher voltage than this voltage.

The motor generator 6 is configured as, for example, a permanent magnet synchronous motor. The motor generator 6 is driven by alternating-current electric power supplied by the power converter 1, and thereby, the vehicle is driven. When the vehicle slows down, the motor generator 6 generates regenerative electrical power.

The power converter 1 includes, in a case 2, a capacitor module 10, a power module 20, a DC/DC converter 30, a charger 40, a DC/DC charge controller 50, and an inverter controller 70. Each of these components is connected electrically by bus bars or wires.

The capacitor module 10 is formed of a plurality of capacitor devices. The capacitor module 10 performs removal of noise and suppression of voltage fluctuation by smoothing the voltage. The capacitor module 10 includes first bus bars 11, second bus bars 12, and electrical power wires 13. The first bus bars 11 include pairs of bus bars that correspond to respective electrodes for three-phase alternating-current electric power and are formed of six bus bars. The second bus bars 12 are formed of two bus bars that correspond to each of a positive electrode and a negative electrode for direct-current electric power.

The first bus bars 11 are connected to the power module 20. The second bus bars 12 are connected to the DC/DC converter 30, relays 61, the battery 5, and an electric compressor (not shown). The electrical power wires 13 are formed of flexible cables (for example, litz wires) and are connected to the charger 40. The first bus bars 11, the second bus bars 12, and the electrical power wires 13 share the positive electrode and the negative electrode in the capacitor module 10.

The power module 20 mutually converts direct-current electric power and alternating-current electric power by turning ON/OFF a plurality of power devices (not shown). ON/OFF control of the plurality of power devices is performed by a driver substrate 21 provided in the power module 20.

The power module 20 is connected to the first bus bars 11 of the capacitor module 10. The first bus bars 11 are formed of three pairs of bus bars formed of the positive electrodes and the negative electrodes. The power module 20 is provided with three-phase output bus bars 24 formed of U-phase, V-phase, and W-phase. The output bus bars 24 are connected to a current sensor 22. The current sensor 22 includes motor-side bus bars 25 that output three-phase alternating-current electric power to the motor generator 6 side.

The inverter controller 70 outputs to the driver substrate 21 a signal for operating the power module 20 on the basis of an instruction from a controller (not shown) of the vehicle and detection results for the electric current of the U-phase, the V-phase, and the W-phase from the current sensor 22. The driver substrate 21 controls the power module 20 on the basis of the signal from the inverter controller 70. An inverter module that mutually converts direct-current electric power and alternating-current electric power is formed of the inverter controller 70, the driver substrate 21, the power module 20, and the capacitor module 10.

The DC/DC converter 30 converts voltage of direct-current electric power supplied from the battery 5 and supplies it to other devices. The DC/DC converter 30 decreases voltage of direct-current electric power from the battery 5 (for example, 400 V) to 12 V direct-current electric power. Direct-current electric power voltage of which has been decreased is supplied as a power supply to the controller, lighting, fan, and so forth mounted on the vehicle. The DC/DC converter 30 is connected to the capacitor module 10 and the battery 5 via the second bus bars 12.

The charger 40 converts commercial power supply (for example, AC 200 V) that is supplied from an external charging connector provided in the vehicle via a normal charging connector 81 to direct-current electric power (for example, 500 V). Direct-current electric power that has been converted by the charger 40 is supplied from the electrical power wires 13 to the battery 5 via the capacitor module 10. Thus, the battery 5 is charged.

The DC/DC charge controller 50 controls driving of the motor generator 6 and charging of the battery 5 performed by the power converter 1. Specifically, on the basis of the instruction from the controller of the vehicle, the DC/DC charge controller 50 controls the charging of the battery 5 by the charger 40 via the normal charging connector 81, charging of the battery 5 via a quick charging connector 63, the driving of the motor generator 6, and the lowering of voltage by the DC/DC converter 30.

A relay controller 60 controls ON/OFF of the relays 61 by the control performed by the DC/DC charge controller 50. The relays 61 are formed of a positive-side relay 61a and a negative-side relay 61b. The relays 61 allow conduction of electricity when connection from the external charging connector is established via the quick charging connector 63 and supplies direct-current electric power (for example 500 V) supplied from the quick charging connector 63 to the second bus bars 12. The battery 5 is charged by direct-current electric power thus supplied.

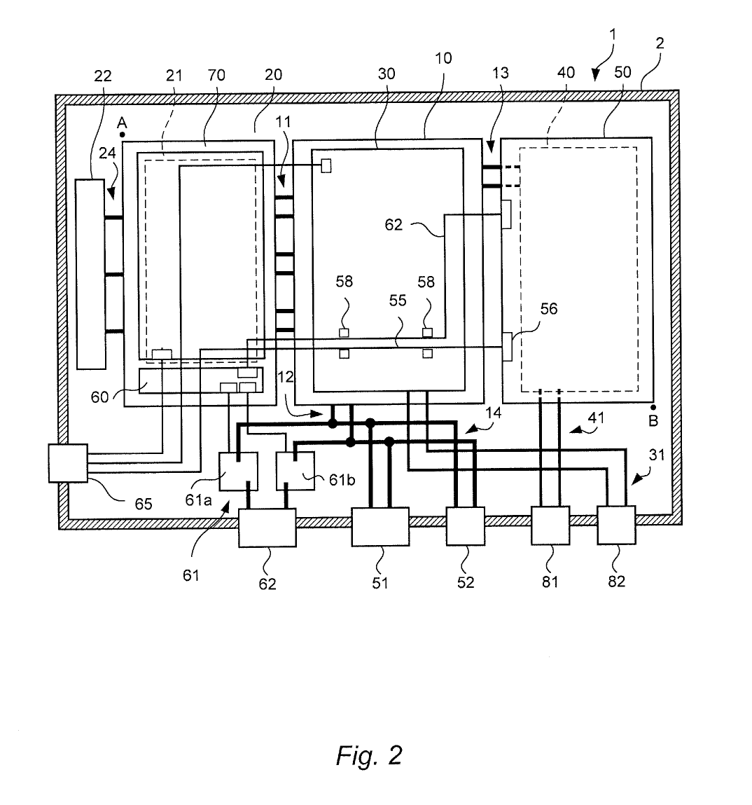

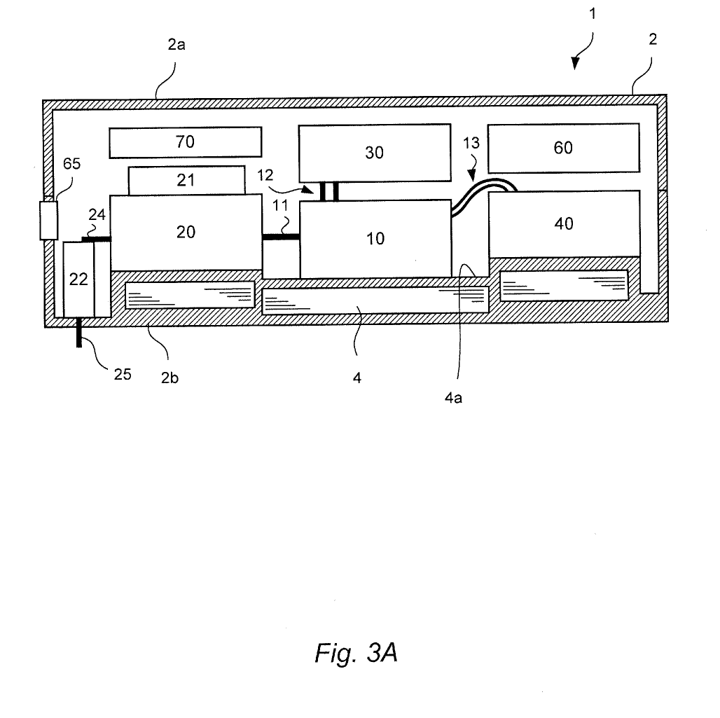

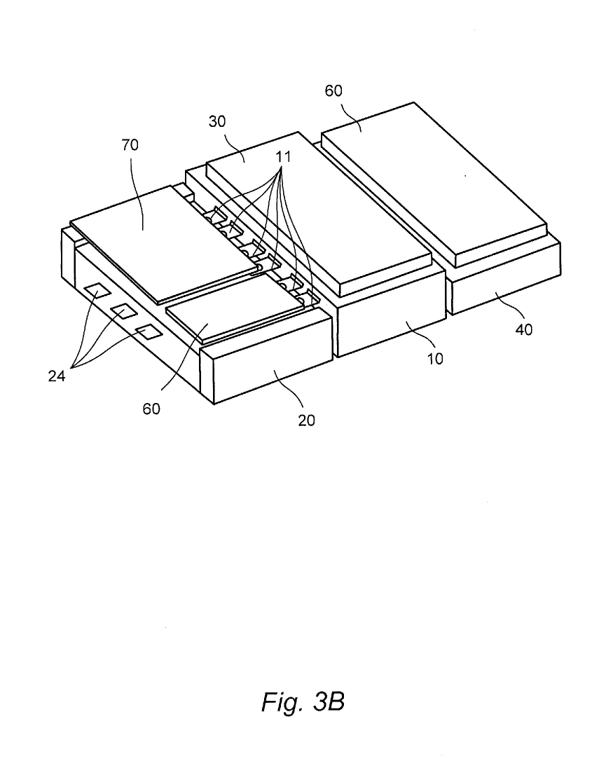

FIGS. 2, 3A, and 3B are structural block diagrams of the power converter 1 of the first embodiment according to the present invention. FIG. 2 is a top view of the power converter 1, FIG. 3A is a side view of the power converter 1, and FIG. 3B is a perspective view of the power converter 1.

In an interior of the case 2, the power module 20, the DC/DC converter 30, and the charger 40 are arranged around the capacitor module 10 so as to be adjacent to the capacitor module 10.

More specifically, in the interior of the case 2, the capacitor module 10 is arranged between the power module 20 and the charger 40 so as to be adjacent to the power module 20 and the charger 40. The capacitor module 10 is arranged so as to directly face the DC/DC converter 30 such that the DC/DC converter 30 is arranged so as to be layered over the capacitor module 10. The charger 40 is arranged so as to directly face the DC/DC charge controller 50 such that the charger 40 is arranged so as to be layered below the DC/DC charge controller 50. In addition, as shown in FIG. 3B, the capacitor module 10 is directly connected to the power module 20 by the first bus bars 11. In other words, the capacitor module 10 and the power module 20 are connected directly by screwing the first bus bars 11 that are provided so as to extend out from the capacitor module 10 to terminals of the power module 20.

The three-phase first bus bars 11 that consist of the U-phase, the V-phase, and the W-phase project out from one side surface of the capacitor module 10. The first bus bars 11 are directly connected to the power module 20 by using screws, etc. Three-phase output bus bars 24 that consist of the U-phase, the V-phase, and the W-phase project out from the power module 20 at the opposite side from the first bus bars 11.

The output bus bars 24 are directly connected to the current sensor 22 by using screws, etc. The motor-side bus bars 25 project out from the bottom side of the current sensor 22 (see FIG. 3A). The motor-side bus bars 25 are respectively connected to the U-phase, the V-phase, and the W-phase of the output bus bars 24 of the power module 20 directly, and output three-phase alternating-current electric power. The motor-side bus bars 25 are formed so as to be exposed from the case 2 and are connected to the motor generator 6 by a harness, etc.

The driver substrate 21 is layered on a top surface of the power module 20. The inverter controller 70 and the relay controller 60 are arranged so as to be layered over the driver substrate 21.

The second bus bars 12 project out from the upper surface side of the capacitor module 10. The second bus bars 12 are connected, by using screws, directly to the DC/DC converter 30 that is arranged so as to be layered over the capacitor module 10. The second bus bars 12 are connected to the positive-side relay 61a and the negative-side relay 61b (see FIG. 1).

The second bus bars 12 are respectively connected via bus bars 14 to a battery-side connector 51 to which the battery 5 is connected and a compressor-side connector 52 to which an electric compressor is connected.

The DC/DC converter 30 is connected to a vehicle-side connector 82 via bus bars 31. The vehicle-side connector 82 is connected to harnesses, etc. for supplying direct-current power supply output from the DC/DC converter 30 to respective parts of the vehicle.

The electrical power wires 13 project out from the side of the capacitor module 10 opposite from the first bus bars 11. The electrical power wires 13 are flexible cables having bendability and are connected to the charger 40. The charger 40 is connected to the normal charging connector 81 via bus bars 41.

A signal line connector 65 allows connection between the outside of the case 2 and the signal lines connected to the DC/DC converter 30, the charger 40, the DC/DC charge controller 50, and the inverter controller 70 of the power converter 1.

A signal line 55 is connected between the signal line connector 65 and the DC/DC charge controller 50. The signal line 55 is connected to a connector 56 of the DC/DC charge controller 50 by extending through a top surface of the DC/DC converter 30 together with a signal line 62 provided so as to extend from the DC/DC charge controller 50 to the relay controller 60. Guide parts 58 for supporting the signal line 55 and the signal line 62 are formed on the top surface of the DC/DC converter 30.

The case 2 is formed of an upper case 2a and a bottom case 2b. A coolant-water channel 4 is formed in the bottom case 2b. The coolant-water channel 4 is formed such that coolant water flows therethrough and cools the power module 20, the capacitor module 10, and the charger 40 mounted directly above the coolant-water channel 4.

As described above, in the first embodiment according to the present invention, the power converter 1 converts and supplies electrical power between the power storage apparatus (the battery 5) and the load (the motor generator 6) and includes: the power module 20 that converts direct-current electric power from the battery 5 and alternating-current electric power supplied to the motor generator 6; the DC/DC converter 30 that converts direct-current voltage from the battery 5; the charger 40 that charges the battery 5 with electrical power supplied via an external connector (the normal charging connector 81); the capacitor module 10 that has capacitors for smoothing voltage; and the case 2 that accommodates the power module 20, the DC/DC converter 30, the charger 40, and the capacitor module 10. In the power converter 1, the power module 20, the DC/DC converter 30, and the charger 40 are arranged around the capacitor module 10 in the case 2.

With the above-mentioned configuration, because the distances between the capacitor module 10 and each of the power module 20, the DC/DC converter 30, and the charger 40 can be made shorter in the case 2, it is possible to reduce resistance (R) and inductance (L) in the paths of direct-current electric power and to reduce electrical power loss and electric noise. Furthermore, because the distances between the capacitor module 10 and each of the power module 20, the DC/DC converter 30, and the charger 40 in the case 2 can be made shorter, it is possible to reduce the size of the power converter 1.

In addition, in the power converter 1 of the first embodiment according to the present invention, the capacitor module 10 is arranged between the power module 20 and the charger 40. In other words, because the capacitor module 10 is arranged between the power module 20 and the charger 40 that generate large amount of heat, it is possible to suppress mutual influence by the heat between the power module 20 and the charger 40. Especially, because operation of the power module 20 (power running and regeneration of the motor generator 6) and operation of the charger 40 (charging of the battery 5 by electrical power from the normal charging connector 81) are not performed at the same time, it is possible to eliminate influence by the heat between the operations.

More specifically, a following situation is expected. In other words, in a case in which the vehicle is charged by using a power charging equipment through the normal charging connector 81 at a garage, a car park, and so forth provided with the power charging equipment, the charger 40 generates the heat as the charger 40 is operated to charge the battery 5. Thereafter, when the vehicle is to be driven, the power module 20 generates the heat as the power module 20 is operated to drive the motor generator 6 by using electrical power from the battery 5. In such a situation, if the charger 40 and the power module 20 are arranged so as to be adjacent to each other, the charger 40 that has already generated the heat and the power module 20 that is to generate the heat as the vehicle is driven are subjected to mutual influence of the heat. In contrast, in the first embodiment according to the present invention, because the capacitor module 10 is arranged between the charger 40 and the power module 20 when viewed in a planar view, it is possible to eliminate the influence by the heat between the charger 40 and the power module 20. The capacitor module 10 is formed of a plurality of capacitor devices. Because the capacitor devices are formed by winding, for example, a laminated metallic and resin film, the thermal capacity per unit volume is large. With such a configuration, even when the amount of heat generation in one of the power module 20 and the charger 40 that is arranged in adjacent to the other is increased, because the thermal capacity of the capacitor module 10 is large, the heat thus generated is received therein and transfer of the heat to the other of the power module 20 and the charger 40 is suppress.

In addition, in the first embodiment according to the present invention, because the DC/DC converter 30 is arranged so as to be layered with the capacitor module 10, the capacitor module 10 and the DC/DC converter 30 are arranged so as to be adjacent in the layered direction in the case 2, and so, it is possible to reduce the size of the power converter 1.

In addition, in the power converter 1 of the first embodiment according to the present invention, the capacitor module 10 includes the first bus bars 11, the second bus bars 12, and the electrical power wires 13, first terminals are connected to the power module 20, second terminals are connected to the DC/DC converter 30, and third terminals are connected to the charger 40. With such a configuration, because electrical power paths between the capacitor module 10 and each of the power module 20, the DC/DC converter 30, and the charger 40 in the case 2 can be made shorter, it is possible to reduce resistance (R) and inductance (L) in the paths of direct-current electric power and to reduce electrical power loss and electric noise, and at the same time, it is possible to reduce the size of the power converter 1.

In addition, in the power converter 1 of the first embodiment according to the present invention, the first terminals and the second terminals are the first bus bars 11 and the second bus bars 12, respectively, and the third terminals are the flexible cables (the electrical power wires 13). With such a configuration, especially because the paths for connecting the third terminals can be arranged freely, the degree of freedom of arrangement of the respective components in the case 2 is increased, and it is possible to reduce the size of the power converter 1.

### Second Embodiment

Next, a second embodiment according to the present invention will be described.

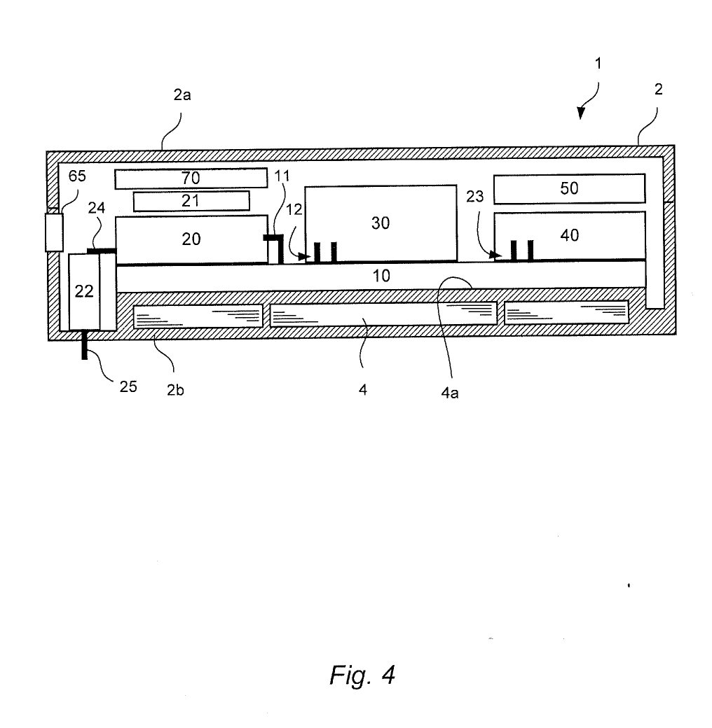

FIG. 4 is a side view of the power converter 1 of the second embodiment according to the present invention.

In the first embodiment, the capacitor module 10 is arranged between the power module 20 and the charger 40, and the DC/DC converter 30 is arranged so as to be layered over the capacitor module 10.

In contrast, in the second embodiment, the capacitor module 10 is mounted on a cooling surface of the case 2, and the power module 20, the DC/DC converter 30, and the charger 40 are mounted above the capacitor module 10.

As shown in FIG. 4, the coolant-water channel 4 is formed in the bottom case 2b. In the bottom case 2b, the thin plate-like capacitor module 10 is mounted above the coolant-water channel 4 so as to cover substantially the whole surface area of the top side of an inner surface (hereinafter, referred to as “a cooling surface 4a”) of the bottom case 2b. In other words the capacitor module 10 is formed so as to have substantially the same area as that of the cooling surface 4a when viewed in a planar view.

The power module 20, the DC/DC converter 30, and the charger 40 are mounted above the capacitor module 10. The DC/DC converter 30 is arranged between the power module 20 and the charger 40.

The capacitor devices forming the capacitor module 10 are formed by laminating, for example, metallic thin films and dielectric thin films. The capacitance of the capacitor module 10 corresponds to the area of the laminated thin films. Thus, it is possible to increase the degree of freedom of the shape by changing the shapes of the thin films and the shapes of the laminate. In this embodiment, by forming the cubic capacitor module 10 such that its external shape becomes thin in the top-down direction as much as possible, the capacitor module 10 is formed to have a thin plate-like shape while ensuring the required capacitance.

As an example, when the capacitor module 10 has a rectangular shape having a diagonal line between a point A and a point B in a planar view shown in FIG. 2, it is possible to form the capacitor module 10 so as to have, in the top-down direction, a thickness of about one third of that of the capacitor module 10 shown in FIGS. 2 and 3A even when the capacitance is the same.

The capacitor module 10 of the second embodiment according to the present invention is arranged over substantially the entire surface below the power module 20, the DC/DC converter 30, and the charger 40, and the bus bars are provided so as to project out towards the upper side of the capacitor module 10. More specifically, the bus bars forming the positive electrodes and the negative electrodes are arranged over the entire inner surface of the thin plate-like capacitor module 10, and the bus bars forming the positive electrodes and the negative electrodes are erected upwards at arbitrary positions. With such a configuration, it is possible to arrange the bus bars at arbitrary positions above the thin plate-like capacitor module.

With such a configuration, it is possible to respectively arrange the first bus bars 11, the second bus bars 12, and third bus bars 23 of the capacitor module 10 at the closest locations to the power module 20, the DC/DC converter 30, and the charger 40 to achieve connections therewith. Therefore, because the electrical power paths between the capacitor module 10 and each of the power module 20, the DC/DC converter 30, and the charger 40 can be made shorter, it is possible to reduce resistance (R) and inductance (L) in the paths of direct-current electric power and to reduce electrical power loss and electric noise, and at the same time, it is possible to reduce the size (thickness) of the power converter 1 in the top-down direction in relation to that of the first embodiment.

In addition, because the bus bars can be arranged at arbitrary positions of the capacitor module 10, it is possible to freely decide locations of the respective components that are arranged above the capacitor module 10. Thus, because the degree of freedom of layout is increased and the degree of freedom arrangement of the respective components in the case 2 of the power converter 1 is increased, it is possible to reduce the size of the power converter 1.

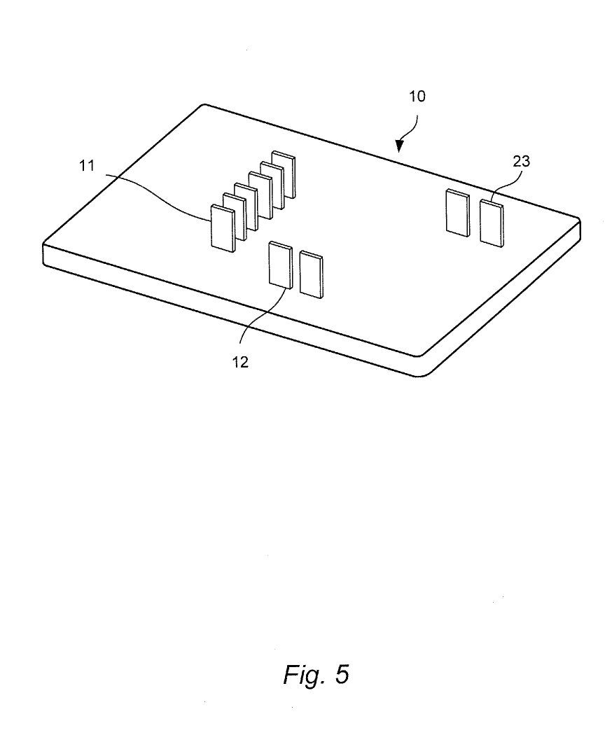

FIG. 5 is a perspective view for explaining the capacitor module 10 of the second embodiment according to the present invention.

The capacitor module 10 includes the first bus bars 11, the second bus bars 12, and the third bus bars 23. The first bus bars 11, the second bus bars 12, and the third bus bars 23 are provided so as to project out to the upper side of the capacitor module 10 and are respectively provided so as to correspond to the positions at which the power module 20, the DC/DC converter 30, and the charger 40 are mounted.

The first bus bars 11 are formed of six bus bars respectively forming pairs of the positive electrodes and the negative electrodes for the U-phase, the V-phase, and the W-phase so as to correspond to input terminals of the power module 20.

The second bus bars 12 are formed of two bus bars forming a pair of the positive electrode and the negative electrode so as to correspond to input terminals of the DC/DC converter 30.

The third bus bars 23 are formed of two bus bars forming a pair of the positive electrode and the negative electrode so as to correspond to input terminals of the charger 40.

When mounted on the top surface of the capacitor module 10, the power module 20, the DC/DC converter 30, and the charger 40 are electrically connected to the first bus bars 11, the second bus bars 12, and the third bus bars 23, respectively.

As described above, in the second embodiment according to the present invention, in the case 2, the thin plate-like capacitor module 10 is arranged on the cooling surface 4a of the bottom case 2b, and the power module 20, the DC/DC converter 30, and the charger 40 are mounted above the capacitor module 10.

As described above, by forming the capacitor module 10 to have a thin plate-like shape and by arranging the capacitor module 10 over substantially the entire surface of the cooling surface 4a of the bottom case 2b, the volume of the capacitor module 10 in the top-down direction occupying the space in the case 2 is reduced, and it is possible to make the power converter 1 thinner.

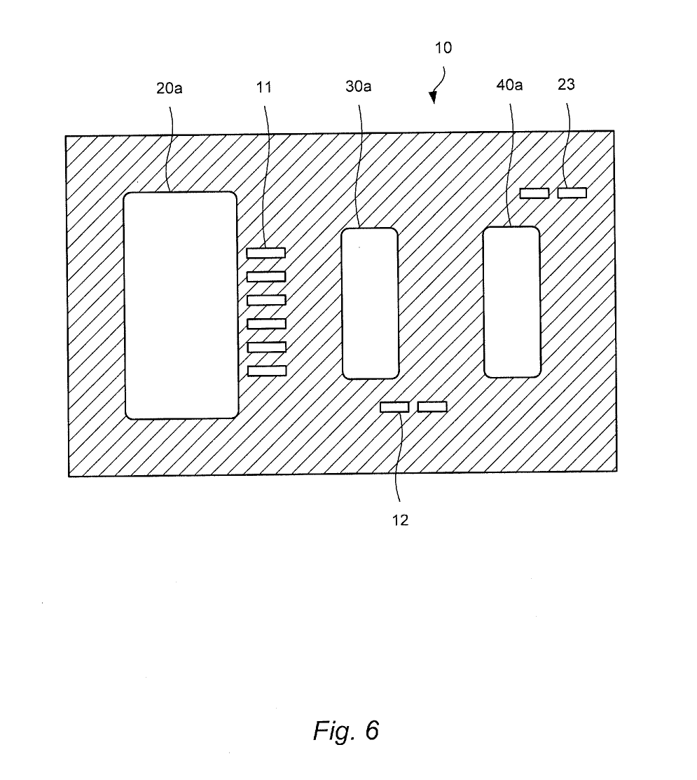

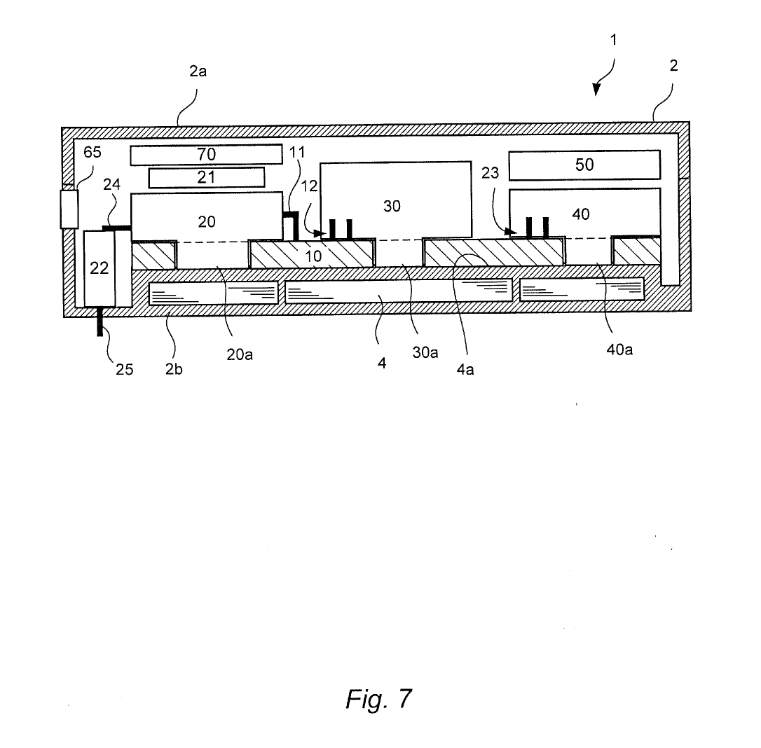

FIG. 6 is an explanatory diagram showing another example configuration of the capacitor module 10 of the second embodiment according to the present invention, and FIG. 7 is a sectional view of the power converter to which the capacitor module of the second embodiment according to the present invention having the another example configuration is applied.

As shown in FIG. 4, when the capacitor module 10 is arranged over substantially the entire surface of the cooling surface 4a of the bottom case 2b, heat resistance between the cooling surface 4a and each of the power module 20, the DC/DC converter 30, and the charger 40 is increased.

Thus, in order to increase cooling efficiency of the power module 20, the DC/DC converter 30, and the charger 40, the capacitor module 10 is provided with opening portions such that the cooling surface 4a is brought into direct contact with the power module 20, the DC/DC converter 30, and the charger 40.

As shown in FIG. 6, an opening portion 20a is formed at a position at which the power module 20 is brought into direct contact with the cooling surface 4a. Similarly, an opening portion 30a is formed at a position at which the DC/DC converter 30 is brought into direct contact with the cooling surface 4a, and an opening portion 40a is formed at a position at which the charger 40 is brought into direct contact with the cooling surface 4a.

As shown in FIG. 7, the power module 20, the DC/DC converter 30, and the charger 40 are respectively provided with heat-conducting portions, which are formed of metal, for example, at positions corresponding to the opening portions 20a, 30a, and 40a. Heat-generating components such as semiconductor devices, inductors, and so forth provided in the power module 20, the DC/DC converter 30, and the charger 40 are subjected to direct heat exchange with the cooling surface 4a via the heat-conducting portions.

As described above, it is possible to change the external shape of the capacitor module 10 in various ways while ensuring capacitance required. Therefore, as shown in FIG. 6, by forming the opening portions such that the power module 20, the DC/DC converter 30, and the charger 40 that are mounted above the capacitor module 10 are brought into direct contact with the cooling surface 4a, it is possible to increase the heat-releasing efficiency and to improve the efficiency of the power converter 1.

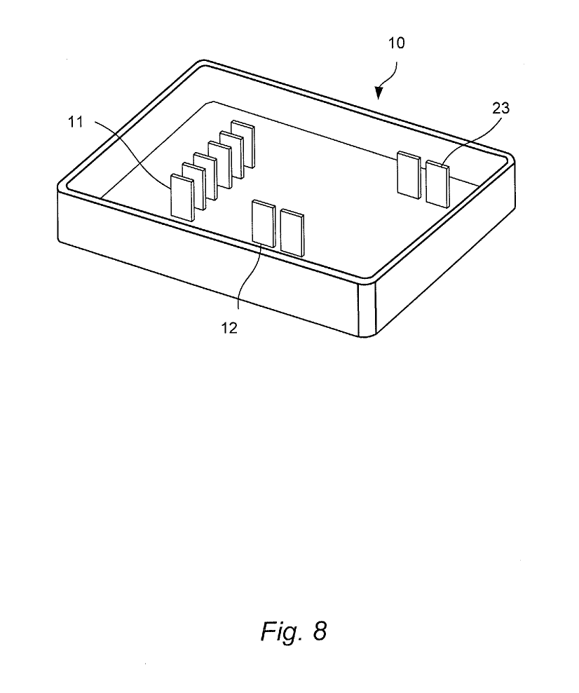

FIG. 8 is an explanatory diagram showing another example configuration of the capacitor module 10 of the second embodiment according to the present invention.

The capacitance of the capacitor module 10 depends on the volume of the laminate of the metallic thin films and the dielectric thin films. Thus, in order to further make the power converter 1 thinner while ensuring capacitance required for the capacitor module 10, the capacitor module 10 may be formed to have a box-like shape, as shown in FIG. 7.

More specifically, by making the thickness of the side of the capacitor module 10 that is in contact with the cooling surface 4a thinner than that of the shape shown in FIG. 5, and by forming the box-like shape with its four sides erected upwards and by utilizing the space corresponding to the erected portions as the capacitor device, it is possible to make the thickness of the surface of the capacitor module 10 in contact with the cooling surface 4a thinner, and therefore, it is possible to make the power converter 1 thinner further more.

Although the embodiments according to the present invention have been described above, the above-mentioned embodiments are only illustrations of one of application examples of the present invention, and there is no intention to limit the technical scope of the present invention to the specific configuration of the above-mentioned embodiments.

Although the capacitor module 10 is connected to the charger 40 by the flexible cables (the electrical power wires 13) in the above-mentioned first embodiment, and the capacitor module 10 is connected to the charger 40 by the bus bars (the third bus bars 23) in the second embodiment, the configurations are not limited thereto. The capacitor module 10 may be connected to the charger 40 by the bus bars, or the capacitor module 10 may be connected to the power module 20 or the DC/DC converter 30 by the flexible cables.

Embodiments of the present invention were described above, but the above embodiments are merely examples of applications of this invention, and the technical scope of this invention is not limited to the specific constitutions of the above embodiments.

This application claims priority based on Japanese Patent Application No. 2016-089221 filed with the Japan Patent Office on Apr. 27, 2016, the entire contents of which are incorporated into this specification.

1-5. (canceled)

6. A power converter for converting and supplying electrical power between a power storage apparatus and a load comprising:
a power module configured to convert direct-current electric power from the power storage apparatus and alternating-current electric power supplied to the load;
a DC/DC converter configured to convert direct-current voltage from the power storage apparatus;
a charger configured to convert alternating-current electric power to direct-current electric power and charge the power storage apparatus therewith, the alternating-current electric power being supplied via an external connector;
a capacitor module connected to the power module, the DC/DC converter, and the charger, the capacitor module having a capacitor for smoothing voltage; and
a case configured to accommodate the power module, the DC/DC converter, the charger, and the capacitor module, the case having a cooling surface; wherein
in the case, the power module, the charger, and the DC/DC converter are arranged around the capacitor module, and the DC/DC converter is arranged between the power module and the charger, and
the capacitor module is arranged on the cooling surface.

7. The power converter according to claim 6, wherein
the capacitor module is formed to have a thin plate-like shape and is mounted on the cooling surface, and
the power module, the DC/DC converter, and the charger are mounted above the capacitor module.

8. The power converter according to claim 6, wherein
the capacitor module is formed so as to have substantially the same area as that of the cooling surface when viewed in a planar view.

9. The power converter according to claim 6, wherein
the capacitor module is provided with a bus bar electrically connected to at least one of the power module, the DC/DC converter, and the charger, the bus bar being provided so as to project upwards.

10. The power converter according to claim 6, wherein
the capacitor module has an opening portion at a position corresponding to at least one of the power module, the DC/DC converter, and the charger, the opening portion being configured such that the power module, the DC/DC converter, or the charger is brought into direct contact with the cooling surface therethrough.
